(19) United States
(12) Patent Application Publication
(10) Pub. No.: US 2024/0125613 A1
(43) Pub. Date: Apr. 18, 2024

(54) MAP GENERATION METHOD AND MAP GENERATION APPARATUS

(71) Applicant: BOE Technology Group Co., Ltd., Beijing (CN)

(72) Inventor: Chong GUO, Beijing (CN)

(21) Appl. No.: 18/273,038

(22) PCT Filed: Mar. 3, 2022
(86) PCT No.: PCT/CN2022/079116

§ 371 Date: Jul. 19, 2023

(30) Foreign Application Priority Data
Jun. 25, 2021 (CN) 202110713509.0

(51) Int. Cl. G01C 21/36; G06T 3/40

(52) U.S. Cl. CPC G01C 21/3667; G06T 3/40

(57) ABSTRACT

The present disclosure relates to map generation methods and map generation apparatuses, the methods include: loading a base class of a server, and calling an API of the server to process geographic information of a target area, to determine a height and width of the target area and coordinates of one or more feature points in the target area; determining a container height and width; determining a canvas height and width according to the height and width, and the container height and width; determining a ratio of a distance to pixels in the canvas; determining pixel coordinates of the feature points in the canvas according to the ratio and the coordinates; and generating a map of the target area in the canvas according to the pixel coordinates.

The present application is a U.S. National Stage of International Application No. PCT/CN2022/079116, filed on Mar. 3, 2022, which claims the benefit of priority to Chinese Application No. 202110713509.0, filed on Jun. 25, 2021, the contents of all of which are incorporated herein by reference in their entireties for all purposes.

### TECHNICAL FIELD

The present disclosure relates to the field of display technologies, and in particular, to map generation methods, map generation apparatuses, terminals, and computer-readable storage media.

### BACKGROUND

At present, a map that a user sees at a client is generally generated by a server and then displayed at the client. To generate the map by the server, the server needs to acquire information of corresponding area of the map first, and then the map of this area can be generated based on the acquired information.

However, the information that the server can acquire is limited, so it is difficult to ensure that when the user needs to view a map of a certain area, the server has acquired information of the area in advance and generated the map of the area, which leads to the user not being able to view the map of the certain area flexibly.

### SUMMARY

The present disclosure provides map generation methods, map generation apparatuses, terminals, and computer-readable storage media, to address deficiencies in related technologies.

According to a first aspect of an embodiment of the present disclosure, a map generation method is proposed, including: loading a base class of a server, and calling an API of the server to process geographic information of a target area, to determine a height and a width of the target area and coordinates of one or more feature points in the target area; determining a container height and a container width of a container for display; determining a canvas height and a canvas width according to the height, the width, the container height and the container width; determining a ratio of a distance to pixels in the canvas; determining pixel coordinates of the feature points in the canvas according to the ratio and the coordinates; and generating a map of the target area in the canvas according to the pixel coordinates.

In an embodiment, determining the canvas height and the canvas width includes: determining that the canvas width is equal to the container width in response to determining that the width is greater than the height, and determining the canvas height according to a product of the canvas width and a ratio of the height to the width; and/or determining that the canvas height is equal to the container height in response to determining that the height is greater than the width, and determining the canvas width according to a product of the canvas height and a ratio of the width to the height.

In an embodiment, determining the ratio of the distance to the pixels in the canvas includes: determining the ratio according to the width and the canvas width, or determining the ratio according to the height and the canvas height.

In an embodiment, the feature point includes: vertices of outline of the target area, vertices of a circumscribed quadrangle of outline of the target area, vertices of a covering outline in the target area or any combination thereof.

In an embodiment, the feature points include the vertices of outline of the target area and the vertices of the circumscribed quadrangle of outline of the target area, where determining the coordinates of the feature points in the target area includes: determining a basic vertex as an origin among the vertices of the circumscribed quadrangle; calculating first distances in a width direction and second distances in a height direction from other feature points excluding the base vertex to the base vertex; and determining coordinates of the other feature points according to the first distances and the second distances.

In an embodiment, the first distances and the second distances are calculated, and the height and the width are determined according to a base class related manner provided by the API.

In an embodiment, the base class related manner provided by the API includes: AMap.GeometryUtil.distance.

In an embodiment, the generating the map includes: saving the pixel coordinates as an array; and generating a polygon corresponding to the pixel coordinates in the canvas by processing the array.

In an embodiment, the method further includes: initializing an object in the canvas, where the object includes the map and/or an element in the map; binding an event for the object, where the event includes an operation and an effect corresponding to the operation.

In an embodiment, the method further includes: binding height information for the object.

In an embodiment, the method further includes: determining a first zoom ratio according to the container width and the canvas width in response to determining the canvas width being greater than the container width, and zooming in the canvas according to the first zoom ratio; determining a second zoom ratio according to the container height and the canvas height in response to determining the canvas height being greater than the container height, and zooming in the canvas according to the second zoom ratio.

In an embodiment, the zooming in the canvas according to the first zoom ratio includes: zooming in the canvas according to the first zoom ratio and a first preset zoom ratio; and/or the zooming in the canvas according to the second zoom ratio includes: zooming in the canvas according to the second zoom ratio and a second preset zoom ratio.

In an embodiment, the method further includes: determining a container center position of the container and a canvas center position of the canvas; determining an offset from the container center position to the canvas center position; moving the zoomed-in canvas according to the offset.

In an embodiment, the method further includes: receiving a route generation request; acquiring maps of other areas other than the target area from the server; when a route requested to be generated passes through the target area, generating the route according to the maps of the other areas and the map of the target area.

According to a second aspect of an embodiment of the present disclosure, a map generation apparatus is proposed, which includes a processor, configured to: load a base class of a server, and call an API of the server to process geographic information of a target area, to determine a height and a width of the target area and coordinates of one or more feature points in the target area; determine a container height and a container width of a container for display; determine a canvas height and a canvas width according to the height, the width, the container height and the container width; determine a ratio of a distance to pixels in the canvas; determine pixel coordinates of the feature points in the canvas according to the ratio factor and the coordinates; and generate a map of the target area in the canvas according to the pixel coordinates.

In an embodiment, the processor is configured to: determine that the canvas width is equal to the container width in response to determining that the width is greater than the height, and determine the canvas height according to a product of the canvas width and a ratio of the height to the width; and/or determine that the canvas height is equal to the container height in response to determining that the height is greater than the width, and determine the canvas width according to a product of the canvas height and a ratio of the width to the height.

In an embodiment, the processor is configured to: determine the ratio according to the width and the canvas width, or determine the ratio according to the height and the canvas height.

In an embodiment, the feature point includes: vertices of outline of the target area, vertices of a circumscribed quadrangle of outline of the target area, vertices of a covering outline in the target area or any combination thereof.

In an embodiment, the feature points include the vertices of outline of the target area and the vertices of the circumscribed quadrangle of outline of the target area, and the processor is configured to: determine a basic vertex as an origin among the vertices of the circumscribed quadrangle; calculate first distances in a width direction and second distances in a height direction from other feature points excluding the base vertex to the base vertex; and determine coordinates of the other feature points according to the first distances and the second distances.

In an embodiment, the first distances and the second distances are calculated, and the height and the width are determined according to a base class related manner provided by the API.

In an embodiment, the base class related manner provided by the API includes: AMap.GeometryUtil.distance.

In an embodiment, the processor is further configured to: initialize an object in the canvas, where the object includes the map and/or an element in the map; bind an event for the object, where the event includes an operation and an effect corresponding to the operation.

In an embodiment, the processor is further configured to: bind height information for the object.

In an embodiment, the processor is further configured to: determine a first zoom ratio according to the container width and the canvas width in response to determining the canvas width being larger than the container width, and zoom in the canvas according to the first zoom ratio; and determine a second zoom ratio according to the container height and the canvas height in response to determining the canvas height being larger than the container height, and zoom in the canvas according to the second zoom ratio.

In an embodiment, the processor is configured to: zoom in the canvas according to the first zoom ratio and a first preset zoom ratio; and/or the zoom in the canvas according to the second zoom ratio includes: zoom in the canvas according to the second zoom ratio and a second preset zoom ratio.

In an embodiment, the processor is further configured to: determine a container center position of the container and a canvas center position of the canvas; determine an offset from the container center position to the canvas center position; move the zoomed-in canvas according to the offset.

In an embodiment, the processor is further configured to: receive a route generation request; acquire maps of other areas other than the target area from the server; when a route requested to be generated passes through the target area, generate the route according to the maps of the other areas and the map of the target area.

According to a third aspect of an embodiment of the present disclosure, a terminal is presented, including: a processor; a memory, configured to store processor-executable instructions; where the processor is configured to implement the above described above.

According to a fourth aspect of an embodiment of the present disclosure, a computer-readable storage medium is proposed, on which a computer program is stored, which, when executed by a processor, realizes the steps in the method described above.

According to the embodiments of the present disclosure, by loading the base class of the server and calling the API of the server, information such as the height, the width, the coordinate and the like of the target area can be determined by using the base class related method provided by the API.

Further, according to the above results, the canvas width, the canvas height and the pixel coordinates of the coordinates in the canvas can be further determined, and finally the map of the target area can be drawn according to the pixel coordinates.

It should be understood that the above general description and the following detailed descriptions are exemplary and explanatory only and do not limit the present disclosure.

### BRIEF DESCRIPTION OF DRAWINGS

The accompanying drawings, which are incorporated in and constitute a part of the specification, illustrate embodiments consistent with the present disclosure, and are used together with the specification to explain the principles of the present disclosure.

FIG. 1 is a schematic flowchart of a map generation method according to an embodiment of the present disclosure.

FIG. 2 is a schematic diagram of a target area according to an embodiment of the present disclosure.

FIG. 3A is a schematic flowchart of another map generation method according to an embodiment of the present disclosure.

FIGS. 3B to 3F are schematic diagrams showing relationships between a canvas and a container according to an embodiment of the present disclosure.

FIG. 4 is a schematic flowchart of yet another map generation method according to an embodiment of the present disclosure.

FIG. 5 is a schematic flowchart of yet another map generation method according to an embodiment of the present disclosure.

FIG. 6 is a schematic flowchart of yet another map generation method according to an embodiment of the present disclosure.

FIG. 7 is a schematic flowchart of yet another map generation method according to an embodiment of the present disclosure.

FIG. 8 is a schematic diagram of a canvas and a container before adjustment according to an embodiment of the present disclosure.

FIG. 9 is a schematic diagram of an adjusted canvas and container according to an embodiment of the present disclosure.

FIG. 10 is a schematic diagram of a further zoomed-in canvas according to an embodiment of the present disclosure.

FIG. 11 is a schematic flowchart of yet another map generation method according to an embodiment of the present disclosure.

FIG. 12 is a schematic diagram of a moved canvas according to an embodiment of the present disclosure.

### DETAILED DESCRIPTION

Reference will now be made in detail to exemplary embodiments, examples of which are illustrated in the accompanying drawings. When the following description refers to the accompanying drawings, unless otherwise indicated, the same numbers in different accompanying drawings indicate the same or similar elements. Embodiments described in the following exemplary embodiments do not represent all embodiments consistent with the present disclosure. Rather, they are merely examples of apparatuses and methods consistent with some aspects of the present disclosure as detailed in the appended claims.

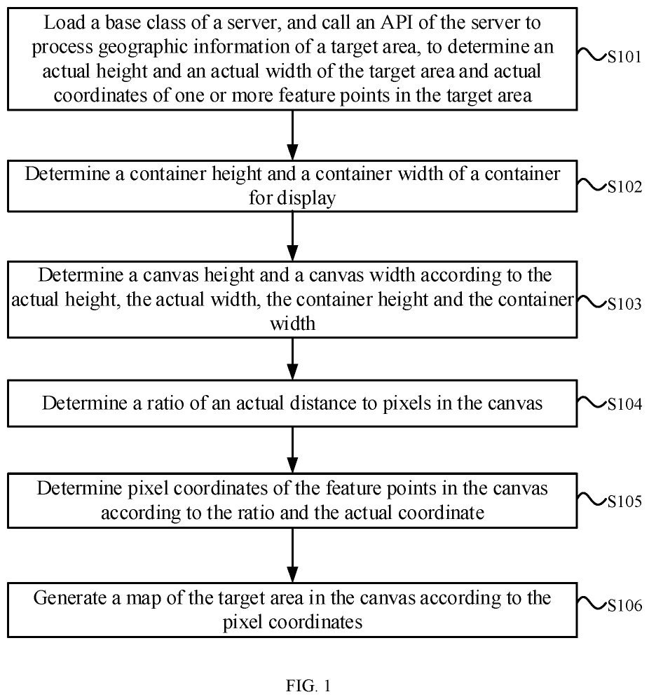

FIG. 1 is a schematic flowchart of a map generation method according to an embodiment of the present disclosure. The method described in this embodiment can be applied to a terminal, including but not limited to a mobile phone, a tablet computer, a personal computer, a wearable device, etc., for example, it can be applied to a browser of the terminal, and it can also be applied to other application programs in the terminal, and the technical solution of the present disclosure will be exemplified below mainly in the case of being applied to a browser.

As shown in FIG. 1, the map generation method may include the following steps:

at step S101, a base class of a server is loaded, and an application programming interface (API) of the server is called to process geographic information of a target area, to determine an actual height and an actual width of the target area and actual coordinates of one or more feature points in the target area.

In an embodiment, a target area can be determined according to an instruction input by a user, for example, an association relationship between the target area and an identifier can be established and saved in advance, and according to an identifier input by the user, the target area corresponding to the identifier can be determined.

The target area has geographical information, for example, an outline of the target area is a polygon, feature points can include vertices of the polygon, vertices of a circumscribed quadrangle of the polygon, and outline vertices of a covering (such as a building) in the area, and the geographical information can include latitude and longitude of the feature points.

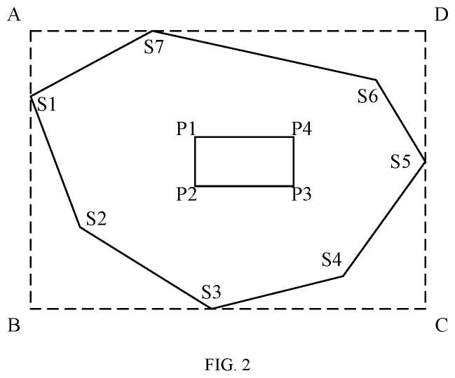

FIG. 2 is a schematic diagram of a target area according to an embodiment of the present disclosure.

As shown in FIG. 2, an outline of a target area is a polygon formed by S1 to S7, and the polygon has seven vertices, and outline vertices of a covering inside a container are P1 to P4, totaling four vertices, and a circumscribed quadrangle of the polygon is ABCD, totaling four vertices.

For the target area shown in FIG. 2, geographic information may include latitude and longitude of S1 to S7, latitude and longitude of P1 to P4, and latitude and longitude of A, B, C and D.

Acquire the latitude and longitude of the feature points shown in FIG. 2, and the returned information can be in json format:

```
const mapData = {
  bound: {
    points: [{
        x: 116.507902,
        y: 39.773947
      },
      {
        x: 116.507903,
        y: 39.781476
      },
      {
        x: 116.518715,
        y: 39.781444
      },
      {
        x: 116.518714,
        y: 39.773915
      },
      {
        x: 116.507962,
        y: 39.773947
      }
    ],
  },
  map: {
    data: {
      points: [{
          x: 116.509311,
          y: 39.780756
        }, {
          x: 116.511042,
          y: 39.781114
        },
        // ......
      ]}
  },
  overlays: [{
    geom: {
      points: [{
          x: 116.50921,
          y: 39.778919
        },
        {
          x: 116.508611,
          y: 39.777593
        },
        {
          x: 116.509368,
          y: 39.777387
        }
        // ......
      ]}
  ]}
}
```

mapData. bound.points represents the latitude and longitude of vertices of circumscribed quadrangle such as the five vertices shown in the above code, and the latitude and longitude of the last vertex coincides with the latitude and longitude of the first vertex. The five vertices can enclose a closed circumscribed quadrangle.

mapData.data.points represents the latitude and longitude of outline vertices of target area. The above code only shows the latitude and longitude of two vertices, and the latitude and longitude of other vertices are omitted in the above code to simplify the description. However, in practical application, there are eight vertices for the embodiment shown in FIG. 2, and the latitude and longitude of the last vertex coincides with the latitude and longitude of the first vertex, which can form a closed polygon.

mapData.overlays.geom.points represents the latitude and longitude of outline vertices of the covering. The above code only shows the latitude and longitude of three vertices, and the latitude and longitude of other vertices are omitted in the above code for simplifying the description. However, in practical application, there are five vertices for the embodiment shown in FIG. 2, and the latitude and longitude of the last vertex coincides with the latitude and longitude of the first vertex. The five vertices can enclose a closed quadrangle.

It should be noted that loading the base class of the server and calling the API of the server can be pre-executed. For example, the browser can load the base class of the server and call the API of the server before determining the target area. Loading the base class of the server and calling the API of the server only need to be executed once, and are not necessarily to be executed every time a map is generated, while other operations need to be executed every time a map is generated.

In an embodiment, the server can be a server capable of displaying and/or drawing maps, and the base class can be a basic class that has the function of displaying and/or drawing maps in the server. For example, the server is an open source server of AMap, and the base class can be an API called by an AMap class, which can be a JSAPI. API can provide a function library AMap.GeometryUtil for calculating spatial information, and the functions in this function library can be used to calculate spatial relationships (e.g. distances, angles) between points, lines and surfaces, lengths, areas, etc. In this embodiment, a base class related manner provided by the API can be applied, for example, method AMap.GeometryUtil.distance in AMap.GeometryUtil.

It should be noted that the base class called above and the manner provided by API are just an example. In practical application, the called base class is not limited to the above AMap, as long as a related manner of the base class can calculate actual distance, and even if the called base class is AMap, a related manner of the base class provided by API is not limited to the above-mentioned AMap.GeometryUtil.distance, as long as the methods can calculate actual records.

Through the called API, for example, based on the base class related method provided by the API, the geographic information of the target area can be processed, for example, calculation can be performed based on the above latitude and longitude to determine an actual height and an actual width of the target area.

For example, the actual height and the actual width of the target area can be determined by the above method AMap.GeometryUtil.distance, and an actual ground distance between two positions can be calculated by the method AMap.GeometryUtil.distance.

For example, an actual width mapWidth is a distance between A and D as shown in FIG. 2, and an actual height mapHeight is a distance between A and B as shown in FIG. 2, then the latitude and longitude of A and D can be substituted into AMap.GeometryUtil.distance to calculate mapWidth, and the latitude and longitude of A and B can be substituted into AMap.GeometryUtil.distance to calculate mapHeight.

mapWidth=AMap.GeometryUtil.distance(A,D), for example, 924.95 meters;

mapHeight=AMap.GeometryUtil.distance(A,B), for example, 838.12 meters.

In addition, actual coordinates of the feature points in the target area can further be determined by the method AMap.GeometryUtil.distance, and the specific way will be explained in the following embodiments.

At step S102, a container height and a container width of a container for display are determined.

At step S103, a canvas height and a canvas width are determined according to the actual height, the actual width, the container height and the container width.

In an embodiment, when a browser is generating a map, the map is to be generated in a container, and for the browser, a container height (a height of visible area of a container) and a container width (a width of visible area of the container) of the container are fixed.

The map is displayed on a canvas, and the canvas can be in a container. Assuming that a Document Object Model (DOM) element where the canvas is located is a container, the container width containerwidth=container.offsetWidth, for example, 1430 pixels, and the container height containerHeight=container.offsetHeight, for example, 700 pixels.

Further, the canvas height canvasHeight and the canvas width canvasWidth can be determined according to the container height and the container width, as well as the actual height and the actual width determined in the previous step, where the units of the calculated canvas height and canvas width can be the number of pixels, that is, the number of pixels corresponding to the canvas in a height direction and the number of pixels corresponding to the canvas in a width direction. A specific way to determine the canvas height and canvas width will be described in detail in the following embodiments.

At step S104, a ratio of an actual distance to pixels in the canvas is determined.

At step S105, pixel coordinates of the one or more feature points in the canvas are determined according to the ratio and the actual coordinate.

At step S106, a map of the target area is generated in the canvas according to the pixel coordinates.

In an embodiment, since the map is generated in the canvas displayed by the browser, and the browser specifically generates images through pixels, in order to display the feature points in the target area in the canvas, the actual coordinates of the feature points are to be converted into pixel coordinates in the browser.

Firstly, the ratio of the actual distance to the pixels in the canvas can be determined, which can represent a relationship between the pixels in the canvas and the actual distance, such as the number of pixels in the canvas corresponding to one meter in the actual distance. For example, if the height and width of pixels are equal, the ratio “factor” can be calculated according to the canvas width and the actual width, for example, factor=canvasWidth/mapWidth, or can be calculated according to the canvas height and the actual height, for example, factor=canvasHeight/mapHeight.

Further, a pixel coordinate of a feature point in the canvas can be determined according to the ratio and the actual coordinate. For example, the actual width can be multiplied by the ratio to determine a value of pixel coordinate in the width direction, and the actual height can be multiplied by the ratio to determine a value of pixel coordinate in the height direction.

That is, the pixel coordinate is (pointX, pointY), where:

pointX=positionX*factor;

pointY=positionY*factor.

Thus, the pixel coordinates corresponding to the feature points in the canvas are determined. After determining the corresponding pixel coordinates of each feature point in the canvas, a map of the target area can be generated in the canvas according to the pixel coordinates, for example, connecting the points corresponding to the pixel coordinates to obtain the outline of the target area.

According to the embodiments of the present disclosure, by loading the base class of the server and calling the API of the server, information such as the actual height, the actual width, the actual coordinates and the like of the target area can be determined by using the base class related method provided by the API. Further, according to the above results, the canvas width, the canvas height and the pixel coordinates of the actual coordinates in the canvas can be further determined, and finally the map of the target area can be drawn according to the pixel coordinates.

In this process, it is not necessary to upload geographic information of the target area to the server, and a user can flexibly select the target area as needed, that is, the map of the target area can be generated locally, which is convenient for the user to view the map of any target area.

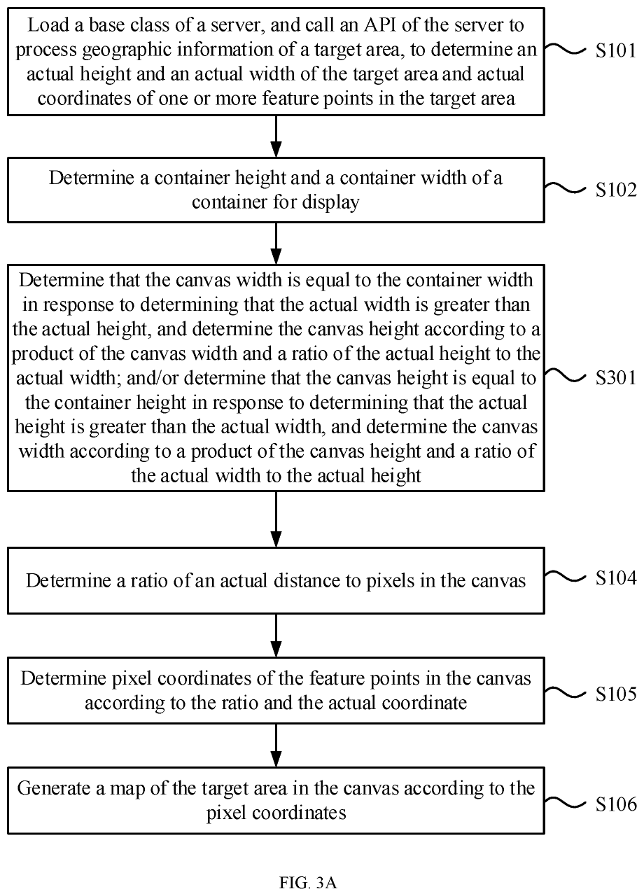

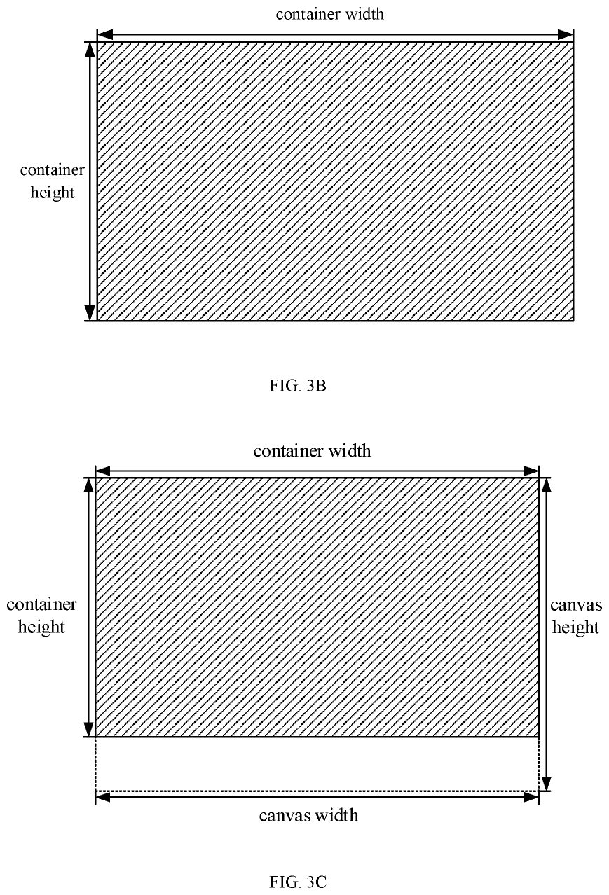

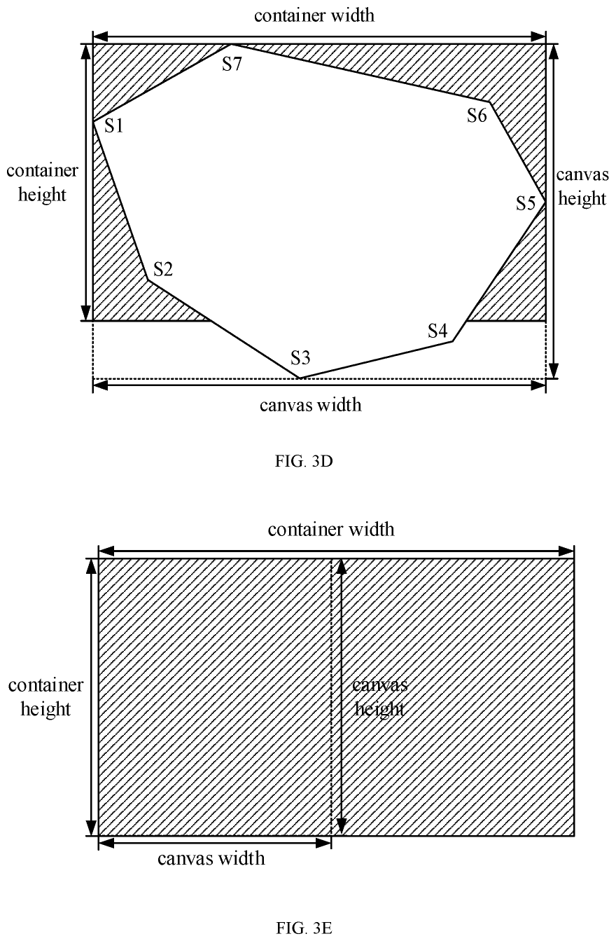

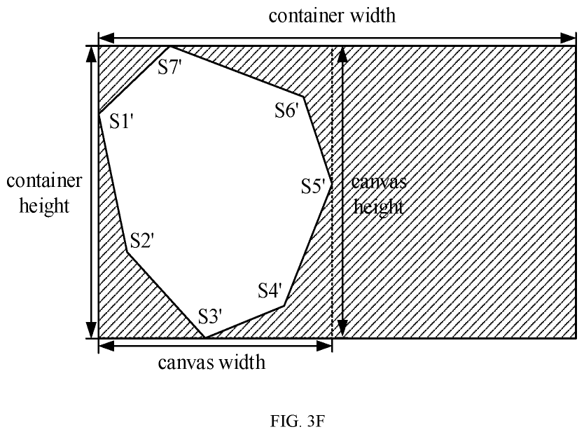

FIG. 3 is a schematic flowchart of another map generation method according to an embodiment of the present disclosure. As shown in FIG. 3, the determining the canvas height and the canvas width according to the actual height, the actual width, the container height and the container width includes:

at step S301, it is determined that the canvas width is equal to the container width in response to determining that the actual width is greater than the actual height, and the canvas height is determined according to a product of the canvas width and a ratio of the actual height to the actual width; and/or it is determined that the canvas height is equal to the container height in response to determining that the actual height is greater than the actual width, and the canvas width is determined according to a product of the canvas height and a ratio of the actual width to the actual height.

In an embodiment, a relationship between the actual width and the actual height can be determined first, and then a larger dimension between the actual width and the actual height can be determined, and a value of a dimension corresponding to the container can be determined as a value of a dimension corresponding to the canvas.

For example, if the actual width is greater than the actual height, it can be determined that the canvasWidth is equal to the containerWidth, for example, equal to 1430 pixels.

It should be noted that the shape of the canvas is rectangular, and the shape of the container is also rectangular. At least one vertex in the canvas coincides with at least one vertex in the container, for example, vertex Q of the canvas coincides with vertex P of the container, and the two sides extending from the vertex Q also coincide with the two sides extending from the vertex P. The embodiments of the present disclosure are mainly described in the case that a top left corner of the canvas coincides with a top left corner of the container.

Since the target area needs to be displayed in the canvas and the canvas needs to be displayed in the container, the width of the canvas can be determined to be equal to the width of the container in the case that the actual width is greater than the actual height, that is, the canvas can fill the container in the width dimension. When the target area is displayed in the canvas, for example, the target area fills the canvas in the dimension of width, then it can eventually make the target area fill the container in the dimension of width, which is conducive to ensuring that the map eventually generated in the container fills the container as much as possible, which is equivalent to the map filling the browser's display area as much as possible, making it easy to view.

Further, in this case, the canvas height canvasHeight can be determined according to the product of the ratio of the actual height to the actual width and the canvas width, where:

canvasHeight=(canvasWidth*mapHeight)/mapWidth, for example, is 1295.76 pixels.

In this way, it can be ensured that when the actual width is adjusted according to a certain ratio (for example, a ratio of canvas width to actual width), the actual height can also be adjusted according to the same ratio, so as to ensure that the width-height ratio of the adjusted target area is consistent with that before adjustment.

For example, as shown in FIG. 3B, a horizontal direction of the canvas is a width direction and a vertical direction is the height direction, and the container width and the container height can be fixed. For example, based on the embodiment shown in FIG. 2, the actual width is greater than the actual height, it can be determined that the canvas width is equal to the container width and the canvas height is equal to:

canvasHeight=(canvasWidth*mapHeight)/mapWidth;

Accordingly, a canvas as shown in FIG. 3C can be obtained, in which the width of the canvas is equal to the width of the container, and the height of the canvas and the height of the container can be different. For example, the height of the canvas determined based on FIG. 2 in FIG. 3C is greater than the height of the container, and as shown in FIG. 3D, a map of the target area shown in FIG. 2 can be generated in the canvas.

When the height of the canvas is greater than the height of the container, the map of the target area in the canvas will also be partially beyond the container, resulting in an incomplete display. This situation can be adjusted, and how to adjust it will be explained in the subsequent embodiments.

Similarly, if the actual height is greater than the actual width, it can be determined that canvasHeight is equal to containerHeight.

Since the target area needs to be displayed in the canvas and the canvas needs to be displayed in the container, the height of the canvas can be determined to be equal to the height of the container in the case that the actual height is greater than the actual width, that is, the canvas can fill the container in the height dimension. When the target area is displayed in the canvas, for example, the target area fills the canvas in the dimension of height, then it can eventually make the target area fill the container in the dimension of height, which is conducive to ensuring that the map eventually generated in the container fills the container as much as possible, which is equivalent to the map filling the browser's display area as much as possible, making it easy to view.

Further, in this case, the canvasWidth can be determined according to the product of the ratio of the actual width to the actual height and the canvas height, where:

canvasWidth=(canvasHeight*mapWidth)/mapHeight.

In this way, it can be ensured that when the actual height is adjusted according to a certain ratio (such as the ratio of the canvas height to the actual height), the actual width can also be adjusted according to the same ratio, so as to ensure that the width-height ratio of the adjusted target area is consistent with that before adjustment.

For example, as shown in FIG. 3B, a horizontal direction of the canvas is a width direction and a vertical direction is the height direction, and the container width and the container height can be fixed. For example, considering that the outline of the target area as shown in S1′ to S7′ in FIG. 3F, and the actual height is greater than the actual width, it can be determined that the canvas height is equal to the container height, and the canvas width is equal to:

canvasWidth=(canvasHeight*mapWidth)/mapHeight;

Accordingly, a canvas can be obtained as shown in FIG. 3E, in which the height of the canvas is equal to the height of the container, and the width of the canvas can be unequal to the width of the container. For example, the width of the canvas determined in FIG. 3C is smaller than the width of the container, and then as shown in FIG. 3F, a map of the target areas can be generated in the canvas.

In an embodiment, the determining the ratio of the actual distance to the pixels in the canvas includes:

determining the ratio according to the actual width and the canvas width, or determining the ratio according to the actual height and the canvas height.

Since canvasHeight/mapHeight=canvasWidth/mapWidth is valid both when the actual width is greater than the actual height and when the actual height is greater than the actual width, the ratio can be determined according to the actual width and the canvas width, or according to the actual height and the canvas height.

For example, factor=canvasWidth/mapWidth;

or factor=canvasHeight/mapHeight.

For example, a calculation result is 1.55, that is, a length of 1 meter in target area accounts for 1.55 pixels in the canvas.

In an embodiment, the feature point includes:

vertices of outline of the target area, vertices of a circumscribed quadrangle of the outline of the target area, vertices of a covering outline in the target area or any combination thereof.

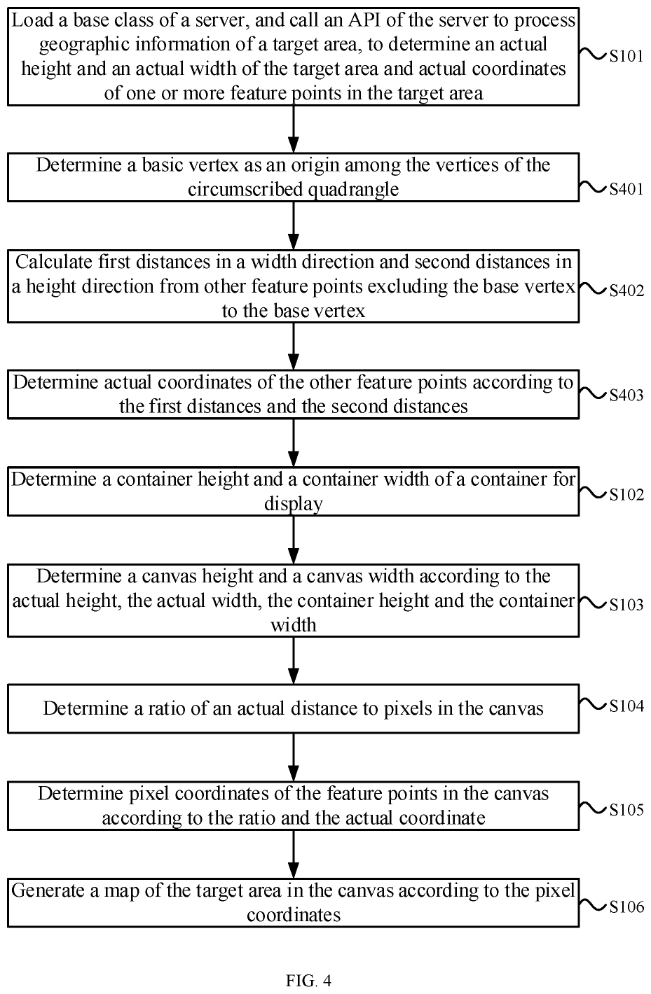

FIG. 4 is a schematic flowchart of yet another map generation method according to an embodiment of the present disclosure. As shown in FIG. 4, the feature points at least include vertices of outline of the target area, vertices of the circumscribed quadrangle of outline of the target area, and the determining the actual coordinates of the feature points in the target area includes:
at step S401, a basic vertex is determined as an origin among the vertices of the circumscribed quadrangle;
at step S402, first distances in a width direction and second distances in a height direction from other feature points excluding the base vertex to the base vertex are calculated;
at step S403, actual coordinates of the other feature points are determined according to the first distances and the second distances.

In an embodiment, one vertex of the circumscribed quadrangle can be determined as an origin, which can be called a base vertex, and then first distances in the width direction and second distances in the height direction from other feature points to the base vertex can be determined, and actual coordinates of the other feature points can be determined according to the first distances and second distances.

Still taking FIG. 2 as an example for description, taking point A in FIG. 2 as an origin, for example, a horizontal distance positionX and a vertical distance positionY of each vertex of the polygon relative to point A can be calculated.

For example, for the vertex S6 in FIG. 2, a vertical line can be drawn from S6 to AD, and an intersection point is S6x, and then a distance between point A and S6x can be calculated by AMap.GeometryUtil.distance as a horizontal distance from S6 to point A. Similarly, a vertical line can be drawn from S6 to AB, and an intersection point is S6y, and then a distance between point A and S6y can be calculated by AMap.GeometryUtil.distance as a vertical distance from S6 to point A.

For each vertex of the polygon, the horizontal distance and vertical distance can be calculated in a similar way.

In an embodiment, the first distances and the second distances are calculated, and the actual height and the actual width are determined according to a base class related manner provided by the API; and the base class related manner provided by the API includes AMap.GeometryUtil.distance. Based on different base classes being loaded, the calculation method can be different. For example, if the base class is AMap, the calculation method is as described above. If other base classes are loaded, the calculation method can also be adjusted accordingly.

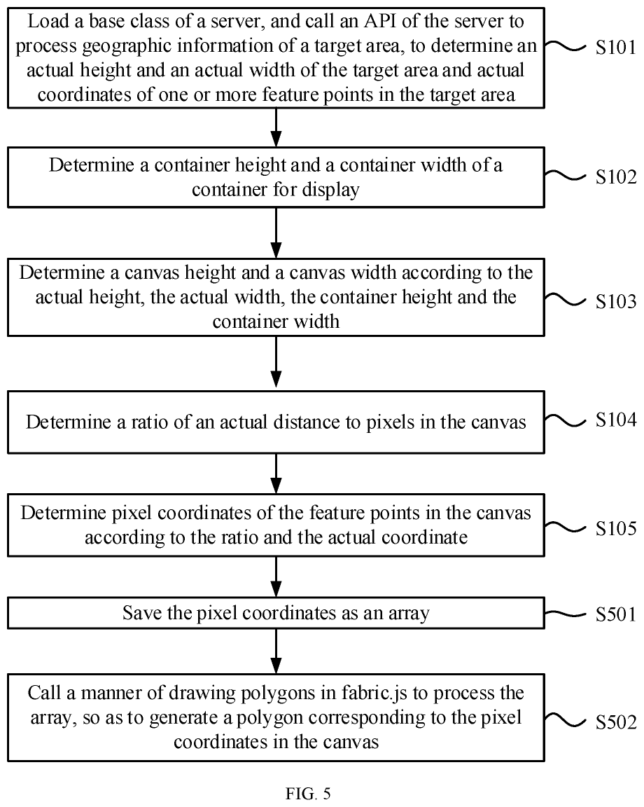

FIG. 5 is a schematic flowchart of yet another map generation method according to an embodiment of the present disclosure. As shown in FIG. 5, the generating the map of the target area in the canvas according to the pixel coordinate includes:
at step S501, the pixel coordinates are saved as an array;
at step S502, a manner of drawing polygons in fabric.js is called to process the array, so as to generate a polygon corresponding to the pixel coordinates in the canvas.

In an embodiment, the pixel coordinates can be saved as an array first, so as to call a method in fabric.js for processing and generate a corresponding polygon in the canvas. For example, a main code for drawing polygons is

const polygon=new fabric.Polygon(points);

canvas.add(polygon);

fabric.js is an open source drawing library based on canvas, which provides a powerful and simple drawing API. Compared to drawing directly with canvas, a code level is more concise, specifically simplifying the operation of native Canvas, for example, functions of object model, Scalable Vector Graphics (SVG) parsing, combining graphics, and generating Canvas object built-in drag and drop functions, which are missing in native Canvas, while fabric.js has the corresponding methods, allowing for direct calling of corresponding methods without the need to edit the code that implements these methods.

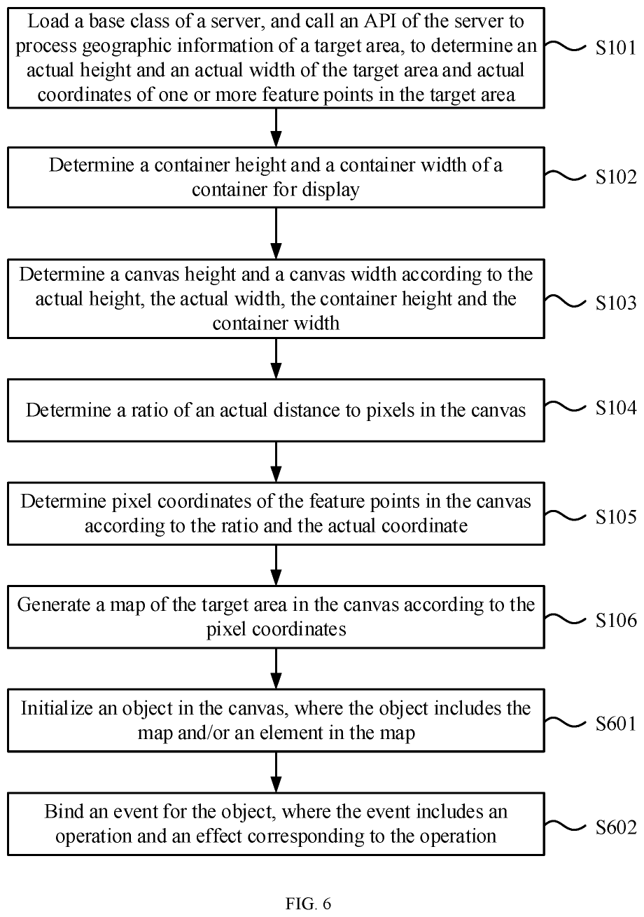

FIG. 6 is a schematic flowchart of yet another map generation method according to an embodiment of the present disclosure. As shown in FIG. 6, the method further includes:
at step S601, an object in the canvas is initialized, where the object includes the map and/or an element in the map;
at step S602, an event is bound for the object, where the event includes an operation and an effect corresponding to the operation.

In an embodiment, objects in the canvas can be initialized, specifically, a map generated in the canvas and elements in the map, for example, the above-mentioned feature points, coverings, etc. For example, the above initialization operation can be completed through the API of fabric, which can be understood as a namespace that contains many classes, such as Canvas, Image, Object, Polygon, Group and related operations, for example:
const canvas=new fabric.Canvas (container); initialize a container where a canvas is located;
   canvas.setWidth(canvasWidth); initialize a canvas width;
   canvas.setHeight(canvasHeight); initialize a canvas height.

Furthermore, events can be bound to objects, and the events include operations and corresponding effects, thus improving an operability of generating the map.

For example, the API of fabric.js can be initialized to pass in a DOM element of the container and the canvas width and the canvas height calculated in the previous steps, thus initializing the canvas object. Operations in binding events include but are not limited to clicking, double clicking, wheel operation, moving in, moving out, etc. Effects of operating the object include, but are not limited to, changing a color, displaying a name, displaying a position, etc.

For example, taking mouse operation as an example, the operation includes clicking an event “mouse:down”, and a corresponding effect is handler1; wheel operation “mouse:wheel”, and a corresponding effect is handler2; moving in a mouse over canvas object “mouse:over”, and a corresponding effect is handler 3; moving out a mouse over canvas object “mouse:out”, and a corresponding effect is handler4. Then the code can be shown as follows:
canvas.on(‘mouse:down’, handler1);
canvas.on(‘mouse:wheel, handler2);
canvas.on(‘mouse:over, handler3);
canvas.on(‘mouse:out, handler4);

For example, if an operation in an event bound to a covering is moving in and moving out, an effect corresponding to moving in is to change the color, and the effect corresponding to moving out is to restore the color, then the color of the covering will change when the user moves the mouse into the covering in the map, and the color of the covering will return to an original state when the mouse is moved out of the covering.

For example, if an operation in an event bound to a feature point is clicking, a corresponding effect is to display a position, then when a user clicks the feature point in the map, the position of the feature point can be displayed (such as latitude, longitude or actual coordinate).

In an embodiment, the method further includes: binding height information for the object.

For an object in the map, height information can further be bound, and the height information can also be included in the above geographic information. For example, if the object is a feature point in the map, the height of the feature point can be directly taken as the height information of the feature point. For example, if the object is a covering in the map, the height information of the covering can be determined according to an average value of the heights of the vertices of the covering outline.

In addition, the height information in geographic information can be continuous or discontinuous, and in the case of discontinuous, it can be included in the geographic information in the form of layers. For example, when the object is a covering in the map, one or more layers can be added to the cover, and each layer has a different height.

By binding the height information to the object, more dimensional information can be provided when watching the map, and it is convenient to use the object in the map for other purposes, for example, determining a route. By considering the height information, the route can be determined more accurately.

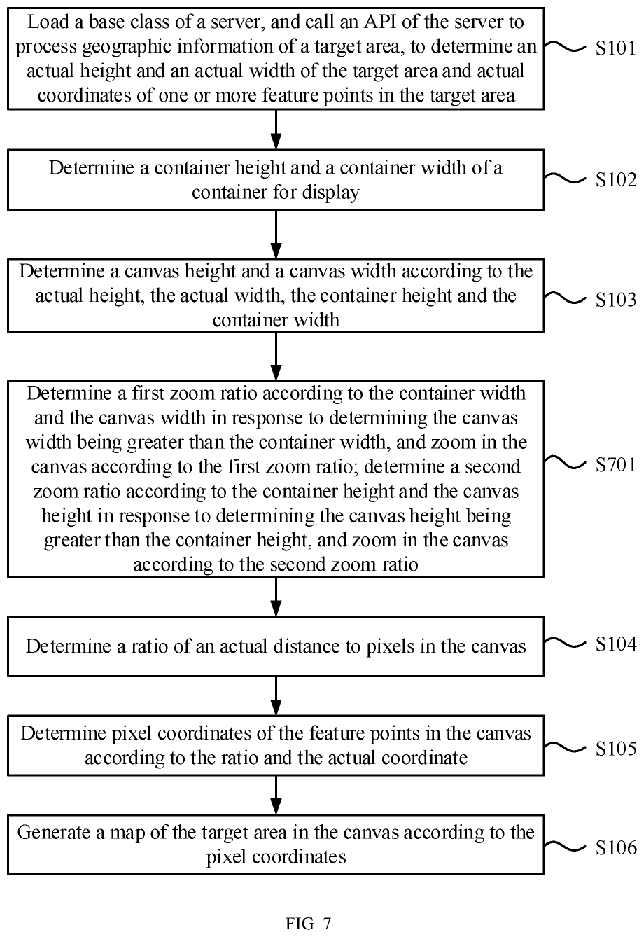

FIG. 7 is a schematic flowchart of yet another map generation method according to an embodiment of the present disclosure. As shown in FIG. 7, the method further includes:

at step S701, a first zoom ratio is determined according to the container width and the canvas width in response to determining the canvas width being greater than the container width, and the canvas is zoomed in according to the first zoom ratio; a second zoom ratio is determined according to the container height and the canvas height in response to determining the canvas height being greater than the container height, and the canvas is zoomed in according to the second zoom ratio.

Because the height and width of the container are fixed, and the height and/or width of the canvas are uncertain because of the influence of the actual height and width, in some cases, the determined canvas width will be greater than the container width, or the determined canvas height will be greater than the container height.

For example, if the canvas width and canvas height are determined according to the embodiment shown in FIG. 3, a height-to-width ratio of the container is 3:4, and a ratio of the actual height to the actual width is 1:1, then if the canvas width is equal to the container width, the canvas height is also equal to the container width, that is, the canvas height is 4:4, the canvas height will be greater than the container height, which leads to the canvas beyond the container in the height direction. The areas inside the container are visible areas, which will cause a part of the canvas beyond the container not to be displayed.

According to the embodiment, when the canvas height is greater than the container height, the second zoom ratio: zoom=(containerHeight/canvasHeight) can be determined according to the container height and the canvas height, and then the canvas can be zoomed in according to the second zoom ratio, thus ensuring that the canvas will not beyond the container in the height direction.

Similarly, when the canvas width is greater than the container width, the first zoom ratio: zoom=(containerWidth/canvasWidth) can be determined according to the container width and the canvas width, and then the canvas can be zoomed in according to the first zoom ratio, thus ensuring that the canvas will not beyond the container in the width direction.

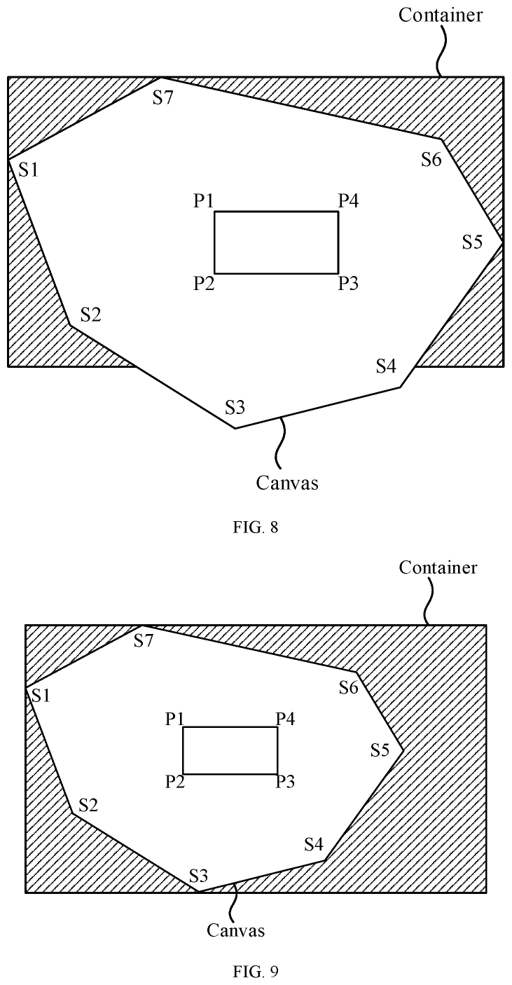

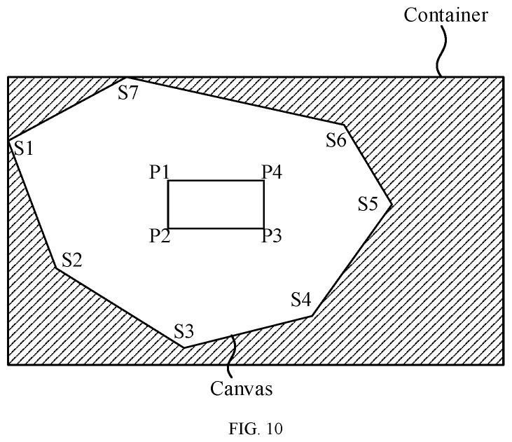

FIG. 8 is a schematic diagram of a canvas and a container before adjustment according to an embodiment of the present disclosure. FIG. 9 is a schematic diagram of an adjusted canvas and container according to an embodiment of the present disclosure.

As shown in FIG. 8, the canvas width is equal to the container width, but the canvas height is greater than the container height, and the canvas beyonds the container in the height direction. Then, the second zoom ratio can be calculated, and then the canvas can be zoomed in by the second zoom ratio, so as to obtain the effect shown in FIG. 9, in which the canvas height is equal to the container height, the canvas width is smaller than the container width, and the canvas is all located in the container, ensuring that all the maps in the canvas can be displayed.

It should be noted that a reference point for zooming operation can be selected as required. For example, in FIG. 8 and FIG. 9, an upper left vertex of the canvas can be used as the reference point for zooming.

For example, an API function “canvas.zoomToPoint (zoomPoint, zoom)” provided by Fabric.js can be used to zoom the canvas, where a parameter “zoomPoint” is the reference point of zooming, and “zoom” is a zoom ratio.

In an embodiment, zooming in the canvas according to the first zoom ratio includes:
zooming in the canvas according to the first zoom ratio and a first preset zoom ratio; and/or
the zooming in the canvas according to the second zoom ratio includes:
zooming in the canvas according to the second zoom ratio and a second preset zoom ratio.

In an embodiment, the canvas may still fill the container in the height or width direction only by zooming in the canvas according to the first zoom ratio or the second zoom ratio, and there may be some inconvenience when viewing and operating the map in the canvas.

Therefore, based on the embodiment shown in FIG. 9, a preset zoom ratio can be further set. For example, in the case where the canvas width is greater than the container width, the canvas can be zoomed in according to the first zoom ratio and a first preset zoom ratio, that is, on the basis of the first zoom ratio, the canvas can be further zoomed in according to the first preset zoom ratio. For example, if the canvas height is greater than the container height, the canvas can be zoomed in according to the second zoom ratio and a second preset zoom ratio, that is, on the basis of the second zoom ratio, the canvas can be further zoomed in according to the second preset zoom ratio.

The first preset zoom ratio and the second preset zoom ratio can be the same or different, for example, they can be set to 90%, 80% etc.

FIG. 10 is a schematic diagram of a further zoomed-in canvas according to an embodiment of the present disclosure. As shown in FIG. 10, a further zoomed-in canvas does not fill the container in both the height and width directions, which helps to improve the viewing effect of the map and the ease of operation.

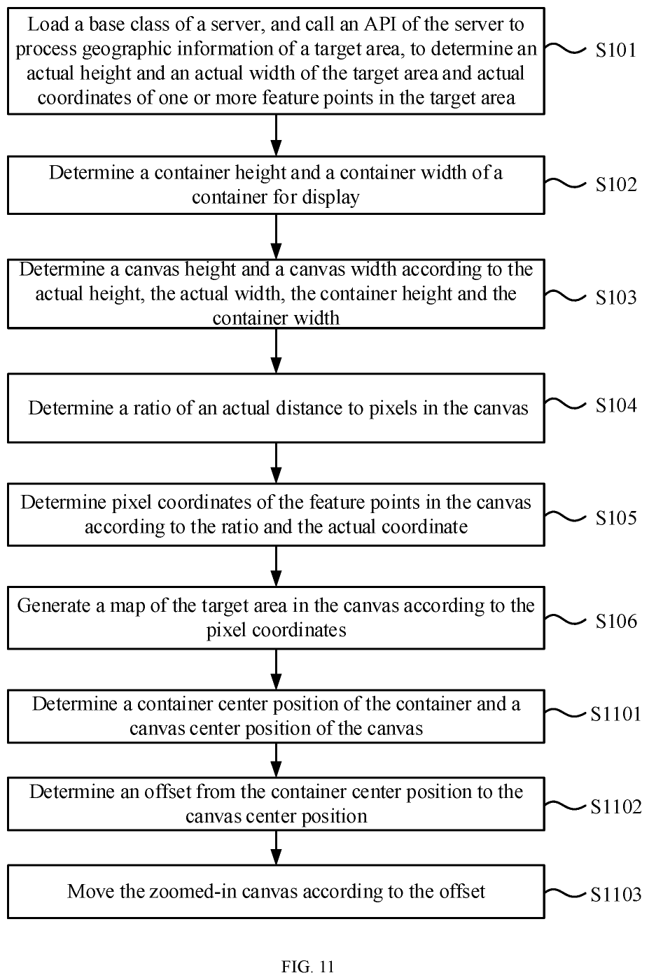

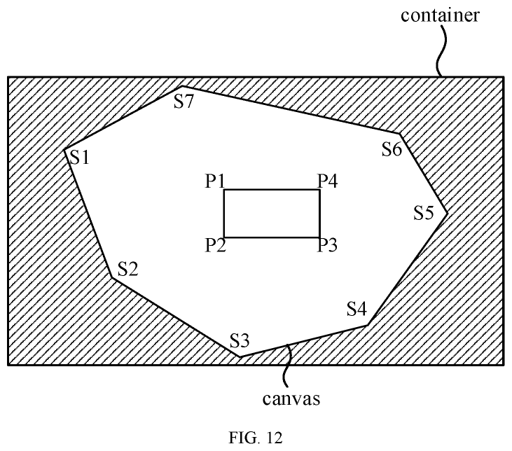

FIG. 11 is a schematic flowchart of yet another map generation method according to an embodiment of the present disclosure. As shown in FIG. 11, the method further includes:
at step S1101, a container center position of the container and a canvas center position of the canvas are determined;
at step S1102, an offset from the container center position to the canvas center position is determined;
at step S1103, the zoomed-in canvas is moved according to the offset.

In an embodiment, because the canvas is zoomed at a certain reference point, the zoomed-in canvas will deviate from the center of the container in most cases, which will affect the viewing effect.

Therefore, the offset from the center of the container to the center of the canvas can be determined, and then the zoomed-in canvas can be moved according to the offset, so that the center of the canvas can coincide with the center of the container, and a good viewing effect can be ensured.

FIG. 12 is a schematic diagram of a moved canvas according to an embodiment of the present disclosure. As shown in FIG. 12, an API function “canvas.relativePan ({x:moveX, y:moveY})” provided by Fabric.js can be used to move the canvas, where moveX is a horizontal (width direction) offset and moveY is a vertical (height direction) offset, and calculation processes are as follows:

moveX=containerWidth/2−(canvasWidth*zoom)/2;

moveY=containerHeight/2−(canvasHeight*zoom)/2.

The center of the moved canvas coincides with the center of the container, so that the canvas is located in the center of the container, ensuring a good viewing effect.

In an embodiment, the method further includes: receiving a route generation request; acquiring maps of other areas other than the target area from the server; when a route requested to be generated passes through the target area, generating the route according to the maps of the other areas and the map of the target area.

In an embodiment, although the map of the target area may be stored in the server, due to the fact that the geographic information of the target area in the embodiment of the present disclosure is generally input by a user, it is more in line with actual needs of the user, so the generated map of the target area is more in line with the actual needs compared with the map of the target area stored in the server. In addition, the server can further store maps of areas other than the target area.

When a route generation request is received, maps of other areas can be acquired from the server, and then a route requested to be generated can be estimated according to a starting point and an ending point in the route generation request. If the route requested to be generated passes through the target area, including passing through the target area, starting from the target area, and ending at the target area, etc., the route can be generated according to the map of the target area generated in the embodiments of the present disclosure and the maps of other areas acquired from the server.

Due to the fact that the map of the target area generated according to the embodiments of the present disclosure is more in line with the actual needs, the route generated according to the map of the target area generated in the embodiment of the present disclosure and the map of other areas acquired from the server is also more in line with the actual needs.

For example, the geographic information of the target area in the present disclosure was determined by the user's recent field investigation. Although a map of the target area may be stored in the server, a timeliness of the geographic information is difficult to be guaranteed compared with that recently determined by the user, so the accuracy is relatively low. That is to say, the map of the target area generated according to the embodiments of the present disclosure can better reflect the recent actual situation of the target area. Therefore, the route generated according to the map of the target area generated in the embodiment of the present disclosure and the maps of other areas acquired from the server is also more accurate.

Corresponding to the above-mentioned embodiments of the map generation methods, the present disclosure further provides embodiments of the map generation apparatuses.

Embodiments of the present disclosure further provide a map generation apparatus, which includes a processor configured to: load a base class of a server, and call an API of the server to process geographic information of a target area, to determine an actual height and an actual width of the target area and actual coordinates of one or more feature points in the target area; determine a container height and a container width of a container for display; determine a canvas height and a canvas width according to the actual height, the actual width, the container height and the container width; determine a ratio of the actual distance to pixels in the canvas; determine pixel coordinates of the feature points in the canvas according to the ratio factor and the actual coordinates; and generate a map of the target area in the canvas according to the pixel coordinates.

In an embodiment, the processor is configured to: determine that the canvas width is equal to the container width in response to determining that the actual width is greater than the actual height, and determine the canvas height according to a product of the canvas width and a ratio of the actual height to the actual width; and/or determine that the canvas height is equal to the container height in response to determining that the actual height is greater than the actual width, and determine the canvas width according to a product of the canvas height and a ratio of the actual width to the actual height.

In an embodiment, the processor is configured to: determine the ratio according to the actual width and the canvas width, or determine the ratio according to the actual height and the canvas height.

In an embodiment, the feature point includes: vertices of outline of the target area, vertices of a circumscribed quadrangle of outline of the target area, vertices of a covering outline in the target area or any combination thereof.

In an embodiment, the feature points include the vertices of outline of the target area and the vertices of the circumscribed quadrangle of outline of the target area, and the processor is configured to: determine a basic vertex as an origin among the vertices of the circumscribed quadrangle; calculate first distances in a width direction and second distances in a height direction from other feature points excluding the base vertex to the base vertex; and determine actual coordinates of the other feature points according to the first distances and the second distances.

In an embodiment, the first distances and the second distances are calculated, and the actual height and the actual width are determined according to a base class related manner provided by the API.

In an embodiment, the processor is further configured to: save the pixel coordinates as an array; and call a manner of drawing polygons in fabric.js to process the array, so as to generate a polygon corresponding to the pixel coordinates in the canvas.

In an embodiment, the base class related manner provided by the API includes: AMap.GeometryUtil.distance.

In an embodiment, the processor is further configured to: initialize an object in the canvas, where the object includes the map and/or an element in the map; bind an event for the object, where the event includes an operation and an effect corresponding to the operation.

In an embodiment, the processor is further configured to: bind height information for the object.

In an embodiment, the processor is further configured to: determine a first zoom ratio according to the container width and the canvas width in response to determining the canvas width being larger than the container width, and zoom in the canvas according to the first zoom ratio; and determine a second zoom ratio according to the container height and the canvas height in response to determining the canvas height being larger than the container height, and zoom in the canvas according to the second zoom ratio.

In an embodiment, the processor is configured to: zoom in the canvas according to the first zoom ratio and a first preset zoom ratio; and/or the zoom in the canvas according to the second zoom ratio includes: zoom in the canvas according to the second zoom ratio and a second preset zoom ratio.

In an embodiment, the processor is further configured to: determine a container center position of the container and a canvas center position of the canvas; determine an offset from the container center position to the canvas center position; move the zoomed-in canvas according to the offset.

In an embodiment, the processor is further configured to: receive a route generation request; acquire maps of other areas other than the target area from the server; when a route requested to be generated passes through the target area, generate the route according to the maps of the other areas and the map of the target area.

An embodiment of the present disclosure further proposes a terminal, including: a processor; a memory, configured to store processor-executable instructions; where the processor is configured to implement the method described in any of the above embodiments.

An embodiment of the present disclosure further proposes a non-transitory computer-readable storage medium, on which a computer program is stored, which, when executed by a processor, implements the steps in the method described in any of the above embodiments.

In the present disclosure, the terms “first” and “second” are only used for descriptive purposes and cannot be understood as indicating or implying relative importance. The term “plurality” refers to two or more, unless otherwise explicitly defined.

Other embodiments of the present disclosure will easily occur to those skilled in the art after considering the specification and practicing the disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as exemplary only, and true scope and spirit of the present disclosure are indicated by the following claims.

It should be understood that the present disclosure is not limited to precise structures described above and shown in the accompanying drawings, and various modifications and changes can be made without departing from its scope. The scope of the present disclosure is limited only by the appended claims.

1. A map generation method, comprising:
loading a base class of a server, and calling an application programming interface (API) of the server to process geographic information of a target area, to determine a height and a width of the target area and coordinates of one or more feature points in the target area;
determining a container height and a container width of a container for display;
determining a canvas height and a canvas width according to the height, the width, the container height and the container width;
determining a ratio of a distance to pixels in the canvas;
determining pixel coordinates of the feature points in the canvas according to the ratio and the coordinates; and
generating a map of the target area in the canvas according to the pixel coordinates.

2. The method according to claim 1, wherein determining the canvas height and the canvas width comprises:
determining that the canvas width is equal to the container width in response to determining that the width is greater than the height, and determining the canvas height according to a product of the canvas width and a ratio of the height to the width;
and/or determining that the canvas height is equal to the container height in response to determining that the height is greater than the width, and determining the canvas width according to a product of the canvas height and a ratio of the width to the height.

3. The method according to claim 2, wherein determining the ratio of the distance to the pixels in the canvas comprises:
determining the ratio according to the width and the canvas width, or determining the ratio according to the height and the canvas height.

4. The method according to claim 1, wherein the feature points comprise:
vertices of outline of the target area, vertices of a circumscribed quadrangle of outline of the target area, vertices of a covering outline in the target area or any combination thereof.

5. The method according to claim 4, wherein the feature points comprise the vertices of outline of the target area and the vertices of the circumscribed quadrangle of outline of the target area, and
wherein determining the coordinates of the feature points in the target area comprises:
determining a basic vertex as an origin among the vertices of the circumscribed quadrangle;
calculating first distances in a width direction and second distances in a height direction from other feature points excluding the base vertex to the base vertex; and
determining coordinates of the other feature points according to the first distances and the second distances.

6. The method according to claim 5, wherein the first distances and second distances are calculated, and the height and the width are determined according to a base class related manner provided by the API.

7. The method according to claim 6, wherein the base class related manner provided by the API comprises AMap.GeometryUtil.distance.

8. The method according to claim 1, wherein generating the map comprises:
saving the pixel coordinates as an array; and
generating a polygon corresponding to the pixel coordinates in the canvas by processing the array.

9. The method according to claim 1, further comprising:
initializing an object in the canvas, wherein the object comprises the map and/or an element in the map;
binding an event for the object, wherein the event comprises an operation and an effect corresponding to the operation.

10. The method according to claim 9, further comprising:
binding height information for the object.

11. The method according to claim 1, further comprising:
determining a first zoom ratio according to the container width and the canvas width in response to determining the canvas width being greater than the container width, and zooming in the canvas according to the first zoom ratio;
determining a second zoom ratio according to the container height and the canvas height in response to determining the canvas height being greater than the container height, and zooming in the canvas according to the second zoom ratio.

12. The method according to claim 11, wherein zooming in the canvas according to the first zoom ratio comprises:
zooming in the canvas according to the first zoom ratio and a first preset zoom ratio; and/or
zooming in the canvas according to the second zoom ratio comprises:
zooming in the canvas according to the second zoom ratio and a second preset zoom ratio.

13. The method according to claim 11, further comprising:
determining a container center position of the container and a canvas center position of the canvas;
determining an offset from the container center position to the canvas center position;
moving the zoomed-in canvas according to the offset.

14. The method according to claim 1, further comprising:
receiving a route generation request;
acquiring maps of other areas other than the target area from the server;
when a route requested to be generated passes through the target area, generating the route according to the maps of the other areas and the map of the target area.

15. A map generation apparatus, comprising a processor, and the processor is configured to:
load a base class of a server, and calling an application programming interface (API) of the server to process geographic information of a target area, to determine a height and a width of the target area and coordinates of one or more feature points in the target area;
determine a container height and a container width of a container for display;
determine a canvas height and a canvas width according to the height, the width, the container height and the container width;
determine a ratio of a distance to pixels in the canvas;
determine pixel coordinates of the feature points in the canvas according to the ratio factor and the coordinates; and
generate a map of the target area in the canvas according to the pixel coordinates.

16. The apparatus according to claim 15, wherein the processor is configured to:
determine that the canvas width is equal to the container width in response to determining that the width is greater than the height, and determine the canvas height according to a product of the canvas width and a ratio of the height to the width;
and/or determine that the canvas height is equal to the container height in response to determining that the height is greater than the width, and determine the canvas width according to a product of the canvas height and a ratio of the width to the height.

17. The apparatus according to claim 15, wherein the processor is configured to:
determine the ratio according to the width and the canvas width when the width is greater than the height;
or determine the ratio according to the height and the canvas height when the height is greater than the width.

18. The apparatus according to claim 15, wherein the feature points comprise:
vertices of outline of the target area, vertices of a circumscribed quadrangle of outline of the target area, vertices of a covering outline in the target area or any combination thereof.

19. The apparatus according to claim 18, wherein the feature points comprise the vertices of outline of the target area and the vertices of the circumscribed quadrangle of outline of the target area, the processor is configured to:
determine a basic vertex as an origin among the vertices of the circumscribed quadrangle;
calculate first distances in a width direction and second distances in a height direction from other feature points excluding the base vertex to the base vertex; and
determine coordinates of the other feature points according to the first distances and the second distances.

20-21. (canceled)

22. A non-transitory computer-readable storage medium, on which a computer program is stored, when the program is executed by a processor, the method according to claim 1 is implemented.
